(19) United States
(12) Patent Application Publication
(10) Pub. No.: US 2007/0245336 A1
(43) Pub. Date: Oct. 18, 2007

(54) Method of generating patch file and computer readable recording medium storing programs for executing the method

(75) Inventors: Jong-suk Lee, Suwon-si (KR); Sung-hyun Cho, Seongnam-si (KR); Sun-bal Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/607,956

(22) Filed: Dec. 4, 2006

(30) Foreign Application Priority Data
Feb. 28, 2006 (KR) 10-2006-0019332

(51) Int. Cl. G06F 9/44

(52) U.S. Cl. 717/168

(57) ABSTRACT

Provided are a method of generating a patch file of an in-place method, which includes “diff” instructions to. update software components installed in a device, and a computer readable recording medium storing programs for executing the method. The method includes setting a working window having the same size as the size of the largest one of a reference file and a target file; generating at least one diff instruction by performing longest common string (LCS) matching in a predetermined direction in the working window; and generating a patch file containing the at least one diff instruction.

### CROSS-REFERENCE TO RELATED PATENT APPLICATION

This application claims priority from Korean Patent Application No. 10-2006-0019332, filed on Feb. 28, 2006, in the Korean Intellectual Property Office, the disclosure of which is incorporated herein in its entirety by reference.

1. Field of the Invention

Apparatuses and methods consistent with the present invention relate to updating software, and more particularly, to generating an in-place type patch file, which includes “diff” instructions to update software components installed in a device, and a computer readable recording medium storing programs for executing the method.

2. Description of the Related Art

To support an automatic, recoverable software update in a consumer electronics (CE) device, a storage space of more than twice an existing program size is necessary. However, most CE devices do not have a sufficient storage space for recovery. To solve this problem, an in-place binary patch technique has been developed. Since the in-place binary patch technique uses a software update method, which comprises partially overlapping a binary image existing in a CE device, automatic update and recovery can be supported with less storage space using the technique.

According to the in-place binary patch technique, an existing file can be updated and recovered using diff instructions, and to perform these processes, the diff instructions must be stored in a nonvolatile storage space. A *.diff patch file is a file storing differences between two objects, and a software update is performed in an in-place method using diff instructions included in the patch file. If the size of the diff instructions is too large, recovery may not be supported due to a lack of memory space, and network resources to transmit the patch file may also be wasted.

FIG. 1 is a diagram for explaining a process of generating diff instructions using a full window according to a related art regular diff method, and FIG. 2 is a diagram for explaining a process of generating diff instructions using a sliding window according to a related art in-place diff method. One of the differences between these two methods is a working window used when diff instructions are generated. The working window indicates a memory portion used for longest common string (LCS) matching, a technique used to search for the same portion and different portions in an existing file and a new file when diff instructions are generated.

Referring to FIGS. 1 and 2, a software update server (not shown) generates diff instructions 110 or 210 by extracting a difference between a reference file 120 or 220 previously transmitted to and stored in a client device (not shown) and a target file 130 or 230 to be newly installed, using LCS matching and transmits the generated diff instructions 110 or 210 as a patch file to the client device. Then, the client device receives the patch file and updates the existing reference file 120 or 220 to the target file 130 or 230 using the diff instructions 110 or 210.

A new target file 140 and a modified existing file 240 show a process of generating the target file 130 or 230 in the update process. That is, the new target file 140 shows a process of generating the target file 130 using the reference file 120 and the diff instructions 110 according to the regular diff method, and the modified existing file 240 shows a process of generating the target file 230 by overlapping the reference file 220 according to the in-place diff method.

FIGS. 1 and 2, the diff instructions 110 or 210 include copy instructions and add instructions. A copy instruction has parameters such as an index of a reference file, which indicates a location at which contents to be copied are recorded, and the length of the contents to be copied, and an add instruction has parameters such as contents to be added and the number of times an add operation is repeated.

Referring to FIG. 1, in the related art regular diff method, the diff instructions 110 are generated by performing LCS matching using a full window as a working window. The diff instructions 110 are performed from the left to the right in the full window. The full window includes the reference file 120 and a memory space corresponding to the new target file 140 to be generated. Since the related art regular diff method uses both the reference file 120 and the new target file 140 as objects of the LCS matching, the probability of matching strings is high. Thus, the related art regular diff method has an advantage that the probability of generating a copy instruction that can reduce the size of a diff patch file as compared to the add instruction can be increased. However, in the related art regular diff method, since the reference file 120 is maintained as it is without overlapping the reference file 120 with the new target file 140 generated while updating software, more storage space is needed. Since most CE devices do not have enough storage space to generate a new file, an existing file must be overlapped in most cases, and thus it is difficult to use the related art regular diff method for CE devices. That is, if a storage space is not enough, diff instructions generated using the full window may generate a wrong target file. For example, if “XXX” is overlapped instead “BBB” in index (4) before a third instruction “Copy 4, 3” of FIG. 1 is performed, a target file becomes “AAAXXXXXX” when the third instruction “Copy 4, 3” of FIG. 1 is performed.

Referring to FIG. 2, the size of the sliding window, which is used as an object of LCS matching, is defined as the size of the reference file 220, and a portion to be used for LCS matching is dynamically moved by moving the sliding window by an amount corresponding to a portion to be overlapped. For example, after “AAA” is copied to the target file 240 by a first instruction “Copy 1, 3” of FIG. 2, subsequent LCS matching is performed by moving the sliding window by three characters. According to the related art in-place diff method, a patch update of the in-place binary patch technique can be supported. However, since many add instructions are generated as illustrated in FIG. 2, the related art in-place diff method generates inefficient diff instructions, and thus, the related art in-place diff method cannot solve a problem of the size of the patch file being large. That is, a patch file must be stored in a nonvolatile memory to recover software when an update of the software fails, and if the size of the patch file is larger than an available memory space, the software cannot be recovered. Thus, a more efficient diff instruction generation technique is required.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention provides a method of generating a patch file to generate diff instructions using a least memory space by efficiently managing an overlapped portion of a working window and efficiently determining a job sequence using an available memory space generated by a size difference between a reference file and a target file, and a computer readable recording medium storing programs for executing the method.

According to an aspect of the present invention, there is provided a method of generating a patch file of an in-place method using a fixed window, the method comprising: setting a working window having the same size as the size of the largest one of a reference file and a target file; generating at least one diff instruction by performing longest common string (LCS) matching in a predetermined direction in the working window; and generating a patch file containing the at least one diff instruction.

If the target file is larger than the reference file, the setting of the working window may comprise setting a window containing the reference file and an available memory space at the end of the reference file, which corresponds to a size difference between the target file and the reference file, and the generating of the at least one diff instruction may comprise generating the at least one diff instruction while proceeding in a backward direction from the available memory space.

The generating of the at least one diff instruction may comprise generating the at least one diff instruction by selecting a direction in which it is predicted that the size of the generated at least one diff instruction is smaller.

According to another aspect of the present invention, there is provided a method of generating a patch file of an in-place method using a fixed window, the method comprising: setting a working window having a predetermined size; calculating the number of times each string included in a reference file and/or a target file is repeated; determining a sequence in which to generate diff instructions by referring to the number of times each string is repeated; generating at least one diff instruction by performing longest common string (LCS) matching in the determined sequence in the working window; and generating a patch file containing the at least one diff instruction.

The calculating of the number of times may comprise calculating of the number of times each string of the reference file is used in the target file, and the determining of the sequence may comprise determining that diff instructions are generated in a sequence from a location of a string that is used the smallest number of times to a location of a string that is used the largest number of times based on the locations of strings in the reference file. The determining of the sequence may further comprise: if a plurality of strings having the same sequence exist, calculating the number of times strings of the target file that correspond to locations of the plurality of strings having the same sequence in the reference file, are repeated in the target file; and determining that diff instructions are generated in a sequence from a location of a string having the largest number of times the string is repeated in the target file to a location of a string having the smallest number of times the string is repeated in the target file based on the locations of the strings in the target file.

The calculating of the number of times may comprise calculating the number of times each string is repeated in the target file, and the determining of the sequence may comprise determining that diff instructions are generated in a sequence from a location of a string having the largest number of times the string is repeated to a location of a string having the smallest number of times the string is repeated based on locations of strings in the target file.

### BRIEF DESCRIPTION OF THE DRAWINGS

The above and other features of the present invention will become more apparent by describing in detail exemplary embodiments thereof with reference to the attached drawings in which:

FIG. 1 is a diagram for explaining a process of generating diff instructions using a full window according to a related art regular diff method;

FIG. 2 is a diagram for explaining a process of generating diff instructions using a sliding window according to a related art in-place diff method;

FIG. 3 is a flowchart illustrating a method of generating a patch file according to an exemplary embodiment of the present invention;

FIG. 4 is a diagram for explaining a process of generating diff instructions using the method illustrated in FIG. 3;

FIGS. 5A and 5B are flowcharts illustrating a method of generating a patch file according to another exemplary embodiment of the present invention;

FIG. 6 is a diagram for explaining a process of generating diff instructions using the method illustrated in FIGS. 5A and 5B; and

FIG. 7 is a flowchart illustrating a method of generating a patch file according to another exemplary embodiment of the present invention.

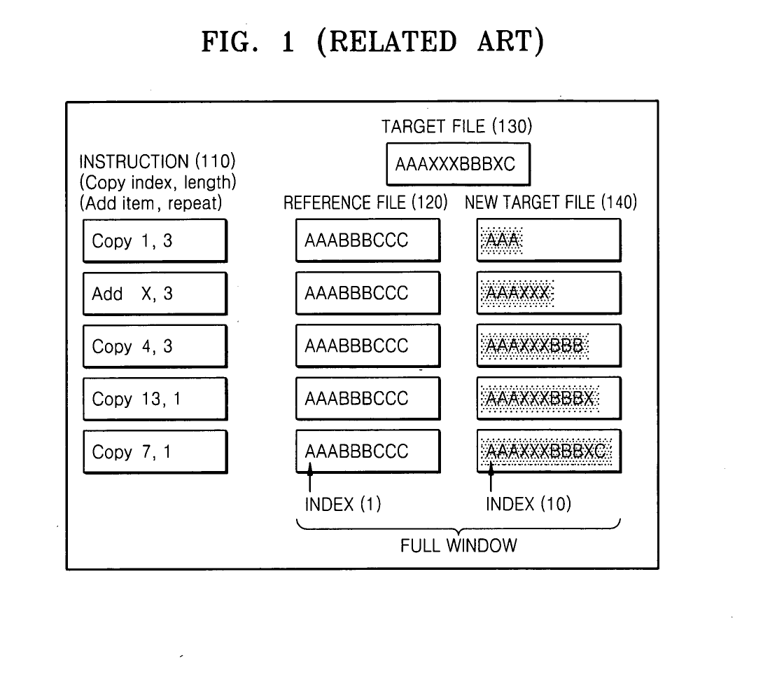

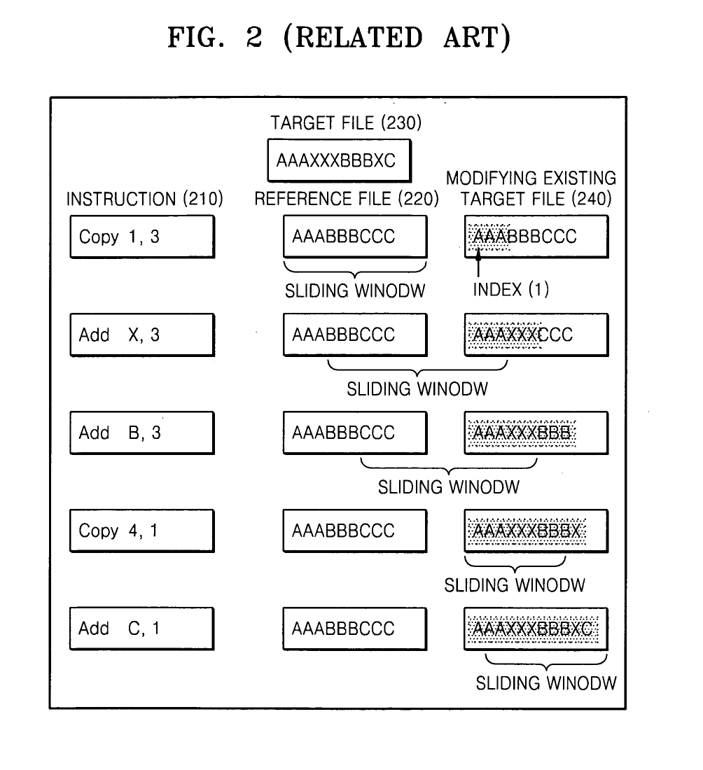

### DETAILED DESCRIPTION OF EXEMPLARY EMBODIMENTS OF THE INVENTION

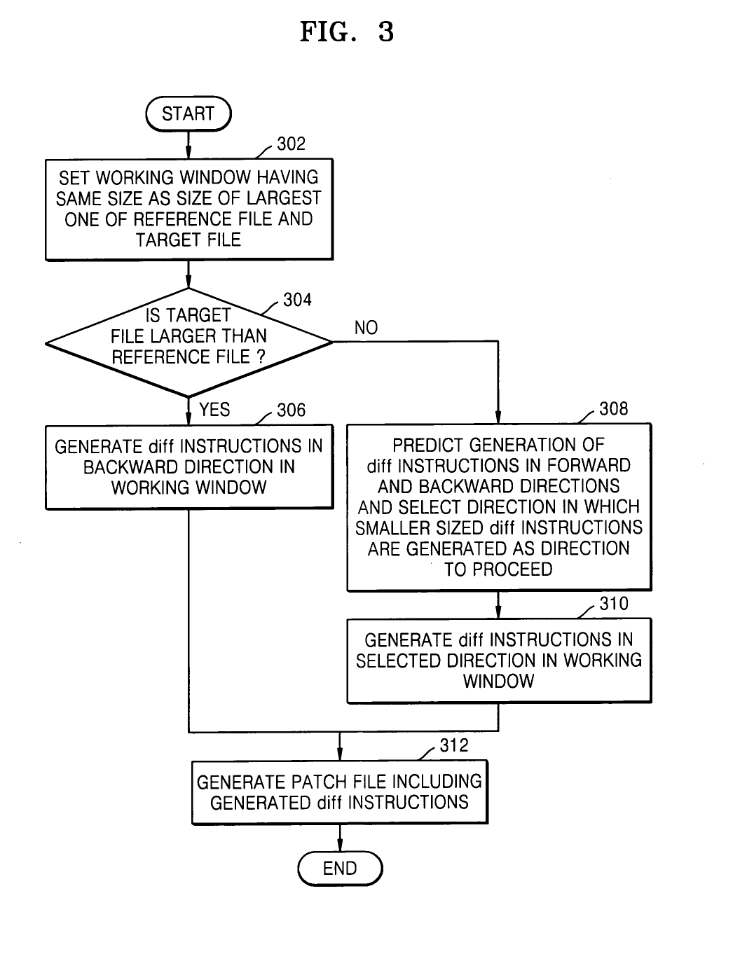

FIG. 3 is a flowchart illustrating a method of generating a patch file according to an exemplary embodiment of the present invention. Referring to FIG. 3, a patch file of the in-place method is generated using a fixed window instead of a sliding window. Unlike a related art sliding window having the same size as a reference file, a working window having the same size as the size of the largest one of a reference file and a target file, is set in operation 302. If the target file is larger than the reference file, a working window including the reference file and an available memory space at the end of the reference file, which corresponds to a size difference between the target file and the reference file, is set. If the reference file is larger than the target file, a working window having the same size as the reference file is set.

The method illustrated in FIG. 3 reduces the number of add instructions, since the probability of finding a portion matching an existing reference file is increased by setting a window size to be large. That is, even if the size of the target file is small, since a working window having the same size as the reference file is set, the maximum window size can always be maintained.

Additionally, the available memory space generated due to the size difference between the target file and the reference file can be used. That is, if the target file is larger than the reference file in operation 304, diff instructions are generated in a backward direction (from the end to the beginning) in the working window in operation 306. In this case, since the available memory space is generated in the end portion of the working window, if the diff instructions are generated in the backward direction by performing LCS matching from the end portion of the working window, the time for which the reference file is overlapped can be extended, and thus, the probability of the LCS matching succeeding increases, thereby increasing the possibility of generating a copy instruction instead of an add instruction. In the related art sliding window method, since a reference file is first overlapped, even if an available memory space exists, a beginning portion of the reference file cannot be used as an object of the LCS matching. However, in the current exemplary embodiment, since the overlapping is performed from the end portion of the available memory space, the reference file can be used efficiently.

If the reference file is equal to or larger than the target file in operation 304, generation of diff instructions is predicted or performed in a forward direction (from the beginning to the end) and in the backward direction, and then a direction in which smaller sized diff instructions are generated is selected as a direction in which to proceed in operation 308. The diff instructions are generated in the selected direction in the working window in operation 310.

The diff instructions generated in operation 306 or 310 are included in a patch file in operation 312 and provided to a user.

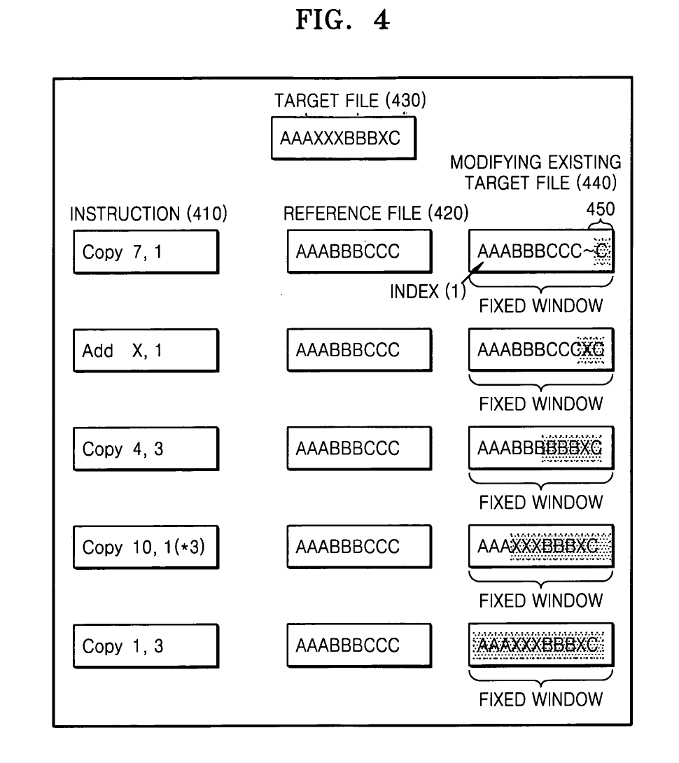

FIG. 4 is a diagram for explaining a process of generating diff instructions using the method illustrated in FIG. 3.

A case where the size of a target file 430 is larger than the size of a reference file 420 is illustrated in FIG. 4. Thus, referring to reference numeral 440, a fixed window is set to include an available memory space 450 corresponding to a size difference between the target file 430 and the reference file 420. In FIG. 4, a copy instruction, which has parameters such as an index of the reference file 420, which indicates locations at which contents to be copied are recorded, and the length of a portion to be copied, and an add instruction, which has parameters such as contents to be added and the number of times an add operation is repeated, are used. In addition, to overlap data from the available memory space 450, a first diff instruction “Copy 7, 1” and a second instruction “Add X, 1” are generated. The instructions are generated in a backward direction. In detail, a copy instruction to copy “C” of index (7) in the end of the fixed window is generated, an add instruction to add “X” once in front of “C” is generated, a copy instruction to copy “BBB” of index (4) in front of “XC” is generated, a copy instruction to copy “X” of index(10) in front of “BBBXC” is generated three times, and a copy instruction to copy “AAA” of index (1) in front of “XXXBBBXC” is generated. When software is updated, the reference file 420 is converted to the target file 430 by overlapping the reference file 420 using the generated diff instructions 410 and the reference file 420.

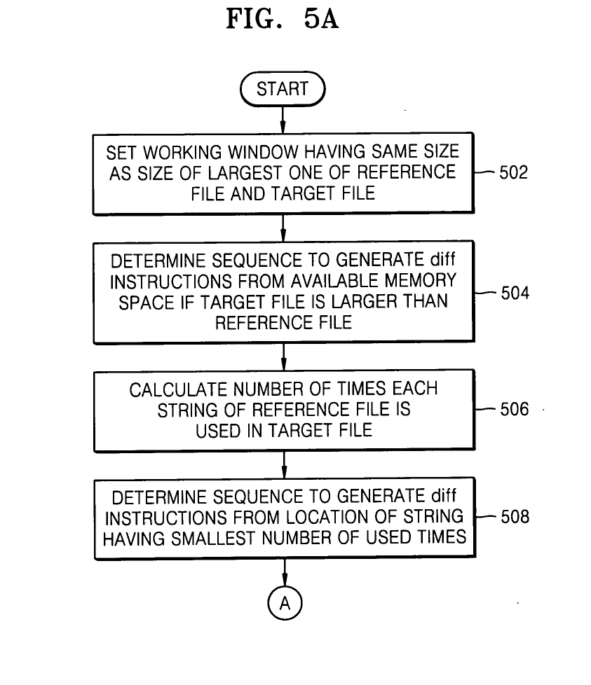

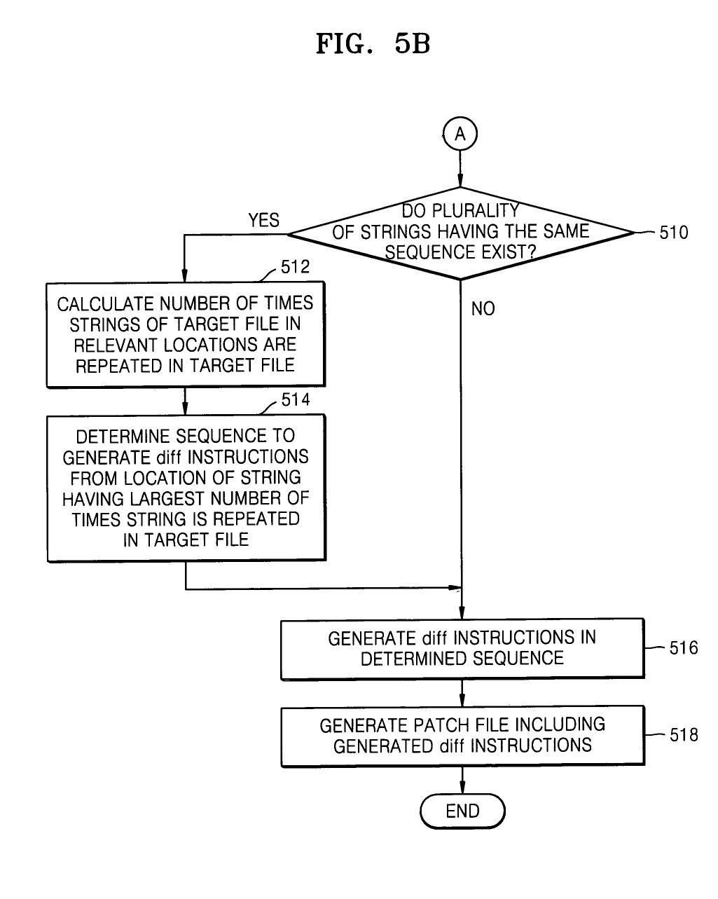

FIGS. 5A and 5B are flowcharts illustrating a method of generating a patch file according to another exemplary embodiment of the present invention.

Referring to FIG. 5A, like the exemplary embodiment illustrated in FIG. 3 a working window having the same size as the size of the largest one of a reference file and a target file, may be set in operation 502. If the target file is larger than the reference file, a working window including the reference file and an available memory space at the end of the reference file, which corresponds to a size difference between the target file and the reference file, may be set. In addition, the available memory space may be used by determining a sequence in which to first generate diff instructions for the available memory space in operation 504.

According to the current exemplary embodiment, to efficiently generate diff instructions instead of sequentially proceeding, for example proceeding in a forward or backward direction, a predetermined sequence in which to generate the diff instructions, i.e., an overlapping sequence of the reference file, is determined by calculating the number of times each string is repeated in the reference file and/or the target file and referring to the calculated number of times each string is repeated.

The current exemplary embodiment uses a method of sorting frequencies of reference strings repeated in the target file, dividing the reference file into a frequently repeated portion and a non-repeated or scarcely repeated portion, overlapping the non-repeated or scarcely repeated portion first, and overlapping the frequently repeated portion next. When a new target file is generated by overlapping the reference file, since an overlapped portion is not an object of the LCS matching, the frequently repeated portion is overlapped late. To do this, the number of times each string of the reference file is used in the target file is calculated in operation 506. To obtain the number of times each string of the reference file is used, i.e., a repeat frequency, a method of dividing the reference file into portions having a specific size (e.g., 16 bytes), obtaining a hash value of each divided portion, and measuring a frequency of the hash value can be used. However, the present invention is not limited thereto. In operation 508, a sequence in which to generate diff instructions is determined which proceeds from a location of a string that is used the smallest number of times to a location of a string that is used the largest number of times based on the locations of strings in the reference file.

Referring to FIG. 5B, if a plurality of strings having the same sequence exist in operation 510, an overlapping sequence of the plurality of strings can be determined using a predetermined criterion. In this case, the probability of the LCS matching succeeding may be increased by first overlapping the frequently repeated portion in the target file. That is, the number of times strings of the target file that correspond to locations of the plurality of strings having the same sequence in the reference file, are repeated in the target file is calculated in operation 512, and it is determined in operation 514 that diff instructions are generated in a sequence from a location of a string having the largest number of times the string is repeated in the target file to a location of a string having the smallest number of times the string is repeated in the target file based on the locations of the strings in the target file.

At least one diff instruction is generated by performing the LCS matching in the working window in the sequence determined as described above in operation 516, and a patch file including the at least one diff instruction is generated in operation 518.

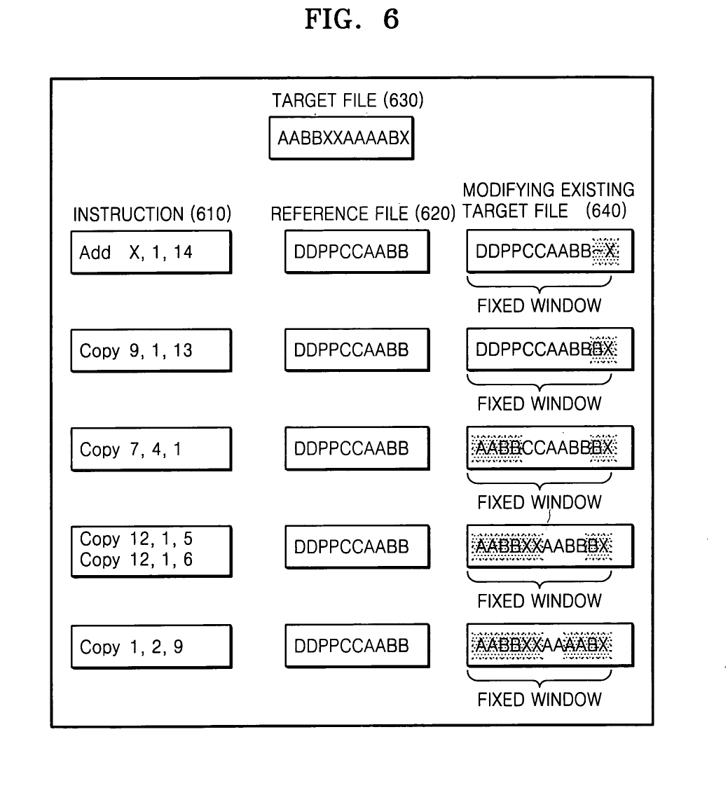

FIG. 6 is a diagram for explaining a process of generating diff instructions using the method illustrated in FIGS. 5A and 5B.

Referring to FIG. 6, diff instructions 610 are generated by comparing a reference file 620 to a target file 630, and a process of converting the reference file 620 to the target file 630 is illustrated in reference numeral 640. However, in FIG. 6, diff instructions having a format different from that illustrated in FIG. 4 are used. That is, both a copy instruction and an add instruction have a third parameter such as an index of the reference file 620, which indicates a location to be overlapped. The third parameter is used to apply a sequence determined based on the number of times each string is repeated in the reference file 620 and/or the target file 630 as described above to the process.

In detail, when the number of times each string of the reference file 620 is repeated in the target file 630 is calculated, “A” is used 6 times, “B” is used 3 times, and “D”, “P”, and “C” are not used. Thus, a diff instruction generation sequence specifies that locations of “D”, “P”, and “C” existing in the reference file 620 have first priority, locations of “Bs” have second priority, and locations of “As” have third priority. Since a plurality of strings having the same priority exist, the numbers of times that “A”, “B”, and “X” of the target file 630, which correspond to locations of “D”, “P”, and “C”, are repeated in the target file 630 is calculated. Since “A”, “B”, and “X” are repeated 6 times, 3 times, and 3 times, respectively, in the target file 630, the locations of “As” are overlapped earlier than the locations of “Xs” based on the locations in the target file 630. That is, based on the locations in the reference file 620, index(1) indicating a location of “D”, is overlapped earlier, and index(5) indicating a location of “C”, is overlapped later. Thus, the sequence is in the order index(14), index(13), index(1), index(5), index(6), and index(9), and the diff instructions 610 for recording “X”, “B”, “AABB”, “X”, “X”, and “AA” in the locations are generated.

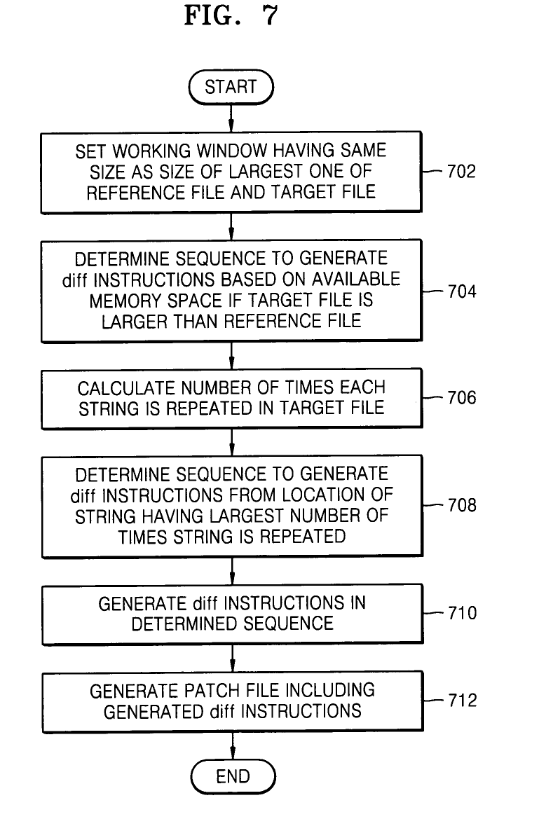

FIG. 7 is a flowchart illustrating a method of generating a patch file according to another exemplary embodiment of the present invention.

Referring to FIG. 7, like the exemplary embodiment illustrated in FIG. 3 a working window having the same size as the size of the largest one of a reference file and a target file, may be set in operation 702. If the target file is larger than the reference file, a working window including the reference file and an available memory space at the end of the reference file, which corresponds to a size difference between the target file and the reference file may be set. In addition, the available memory space may be used by determining a sequence to first generate diff instructions for the available memory space in operation 704.

The current exemplary embodiment uses a method of sorting frequencies of strings repeated in the target file, dividing the reference file into a frequently repeated portion and a non-repeated or scarcely repeated portion, overlapping the frequently repeated portion first, and overlapping the non-repeated or scarcely repeated portion next. This method is efficient because the frequently repeated portion can be used as an object of the LCS matching by being recorded first. To do this, the number of times each string is repeated in the target file is calculated in operation 706. To obtain a repeat frequency, a method of dividing the target file into portions having a specific size (e.g., 16 bytes), obtaining a hash value of each divided portion, and measuring a frequency of the hash value can be used. However, the present invention is not limited thereto. In operation 708, a sequence is determined to generate diff instructions in a sequence from a location of a string having the largest number of times the string is repeated to a location of a string having the smallest number of times the string is repeated based on the locations of strings in the target file.

At least one diff instruction is generated by performing the LCS matching in the working window in the sequence determined as described above in operation 710, and a patch file including the at least one diff instruction, is generated in operation 712.

The above-described method according to an exemplary embodiment of the present invention can also be embodied as computer readable codes on a computer readable recording medium.

As described above, according to the present invention, since the size of a patch file can be significantly reduced by reducing the number of add instructions, a recoverable software update can be supported even in CE devices having a small nonvolatile storage space, and network resources required to transmit the patch file can be saved.

In detail, since the size of a working window is set larger than a related art sliding window method, the probability of successful LCS matching be increased, thereby reducing the number of add instructions. In addition, if the size of a target file is larger than the size of a reference file, an available memory space can be used first. In particular, if a size difference between the target file and the reference file is great, the size of diff instructions can be significantly reduced.

In addition, in the related art sliding window method, since sequential overlapping is performed from the beginning without efficiently overlapping a portion not to be used as an object of LCS matching, even if a string frequently repeated in a target file exists in a beginning portion of a reference file, the beginning portion is overlapped early, and thus the frequently repeated string cannot be used. However, according to the present invention, since a portion not to be used as an object of LCS matching is overlapped first, the probability of successful LCS matching can be increased.

In addition, since a portion in which a string frequently repeated in a target file is recorded is used as an object of LCS matching by being overlapped first, the probability of successful LCS matching can be increased.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope should be construed as being included in the present invention.

What is claimed is:

1. A method of generating a patch file of an in-place method using a fixed window, the method comprising:
setting a size of a working window having a same size as a size of a largest one of a reference file and a target file;
generating at least one diff instruction by performing longest common string (LCS) matching in a predetermined direction in the working window; and
generating a patch file containing the at least one diff instruction.

2. The method of claim 1, wherein if the target file is larger than the reference file,
the setting of the working window comprises setting a window comprising the reference file and an available memory space at an end of the reference file, which corresponds to a size difference between the target file and the reference file, and
the generating of the at least one diff instruction comprises generating the at least one diff instruction while proceeding in a backward direction from the available memory space.

3. The method of claim 1, wherein the generating of the at least one diff instruction comprises generating the at least one diff instruction by selecting a direction in which a size of the generated at least one diff instruction is predicted to be smaller.

4. A method of generating a patch file of an in-place method using a fixed window, the method comprising:
setting a working window having a predetermined size;
calculating a number of times each string included in at least one of a reference file and a target file is repeated;
determining a sequence in which to generate diff instructions by referring to the number of times each string is repeated;
generating at least one diff instruction by performing longest common string (LCS) matching in the determined sequence in the working window; and
generating a patch file comprising the at least one diff instruction.

5. The method of claim 4, wherein the calculating of the number of times comprises calculating a number of times each string of the reference file is used in the target file, and
wherein the determining of the sequence comprises determining that diff instructions are generated in a sequence from a location of a string used a smallest number of times to a location of a string used a largest number of times based on locations of strings in the reference file.

6. The method of claim 5, wherein the setting of the working window having a predetermined size comprises setting a window having a same size as a size of a largest one of the reference file and the target file.

7. The method of claim 6, wherein if the target file is larger than the reference file,
the setting of the working window having a predetermined size comprises setting a window comprising the reference file and an available memory space at an end of the reference file, which corresponds to a size difference between the target file and the reference file, and
the determining of the sequence comprises determining to generate diff instructions for the available memory space first.

8. The method of claim 5, wherein the determining of the sequence further comprises:
if a plurality of strings have a same sequence, calculating a number of times strings of the target file that correspond to locations of the plurality of strings having the same sequence in the reference file are repeated in the target file; and
determining that diff instructions are generated in a sequence from a location of a string having a largest number of times the string is repeated in the target file to a location of a string having a smallest number of times the string is repeated in the target file based on the locations of the strings in the target file.

9. The method of claim 4, wherein the calculating of the number of times comprises calculating a number of times each string in the target file is repeated, and
the determining of the sequence comprises determining that diff instructions are generated in a sequence from a location of a string having a largest number of times the string is repeated to a location of a string having a smallest number of times the string is repeated based on locations of strings in the target file.

10. The method of claim 9, wherein the setting of the working window having a predetermined size comprises setting a window having a same size as a size of a largest one of a reference file and a target file.

11. The method of claim 10, wherein if the target file is larger than the reference file,
the setting of the working window having a predetermined size comprises setting a window comprising the reference file and an available memory space at the end of the reference file, which corresponds to a size difference between the target file and the reference file, and
the determining of the sequence comprises determining to generate diff instructions for the available memory space first.

12. A computer readable recording medium storing a program for executing a method of generating a patch file of an in-place method using a fixed window, the method comprising:
setting a working window having a same size as a size of a largest one of a reference file and a target file;
if the target file is larger than the reference file, generating at least one diff instruction by performing longest common string (LCS) matching in a backward direction from an available memory space existing in an end of the working window, and if the target file is not larger than the reference file, generating at least one diff instruction by performing LCS matching in a predetermined direction in the working window; and
generating a patch file containing the at least one diff instruction.

13. The method of claim 12, wherein if the target file is not larger than the reference file, the generating of the at least one diff instruction comprises generating the at least one diff instruction by selecting a direction in which a size of the generated at least one diff instruction is predicted to be smaller.

14. A computer readable recording medium storing a program for executing a method of generating a patch file of an in-place method using a fixed window, the method comprising:
setting a working window having a predetermined size;
calculating a number of times each string of a reference file is used in a target file;
determining a sequence in which to generate diff instructions as a sequence from a location of a string used a smallest number of times to a location of a string used a largest number of times based on locations of the strings in the reference file;
generating at least one diff instruction by performing longest common string (LCS) matching in the determined sequence in the working window; and
generating a patch file containing the at least one diff instruction.

15. The method of claim 14, wherein the determining of the sequence further comprises:
if a plurality of strings having the same sequence exist, calculating a number of times strings of the target file that correspond to locations of the plurality of strings having a same sequence in the reference file are repeated in the target file; and
determining that diff instructions are generated in a sequence from a location of a string having a largest number of times the string is repeated in the target file to a location of a string having a smallest number of times the string is repeated in the target file based on the locations of the strings in the target file.

16. A computer readable recording medium storing a program for executing a method of generating a patch file of an in-place method using a fixed window, the method comprising:
setting a working window having a predetermined size;
calculating the number of times each string is repeated in a target file;
determining a sequence in which to generate diff instructions as a sequence from a location of a string used a largest number of times to a location of a string used a smallest number of times based on the locations of strings in the target file;
generating at least one diff instruction by performing longest common string (LCS) matching in the determined sequence in the working window; and
generating a patch file containing the at least one diff instruction.
